(19) United States
(12) Patent Application Publication
(10) Pub. No.: US 2016/0347224 A1
(43) Pub. Date: Dec. 1, 2016

(54) THIN SEAT WITH PLASTIC MATRIX AND THIN FOAM

(71) Applicant: Ford Global Technologies, LLC, Dearborn, MI (US)

(72) Inventors: Johnathan Andrew Line, Northville, MI (US); Marcos Silva Kondrad, Macomb, MI (US); John W. Jaranson, Dearborn, MI (US); S. M. Akbar Berry, Windsor (CA); Daniel Ferretti, Commerce Township, MI (US)

(73) Assignee: Ford Global Technologies, LLC

(21) Appl. No.: 14/725,513

(22) Filed: May 29, 2015

(51) Int. Cl. B60N 2/68; B60N 2/64; B60N 2/48; B60N 2/56

(52) U.S. Cl. CPC B60N 2/686; B60N 2/5657; B60N 2/646; B60N 2/48

(57) ABSTRACT

A vehicle seating assembly includes a support frame partially enclosed by a panel assembly. A carrier is defined by a unitary polymeric matrix. A cushion assembly is molded over the carrier. An external peripheral gap is defined between the panel assembly and the carrier. The carrier and the cushion assembly are configured to flex under the weight of a passenger while the support frame remains stationary. An air movement assembly is in communication with the cushion assembly and is configured to move air through the carrier and the cushion assembly proximate a seating surface of the cushion assembly.

### FIELD OF THE DISCLOSURE

The present invention generally relates to a thin seat for a vehicle, and more particularly relates to a thin seat for use in a vehicle with a plastic matrix and thin foam.

### BACKGROUND OF THE DISCLOSURE

Traditional vehicle seating has frequently included a seat frame that supports a matrix of springs that support a thick cushion thereon. These constructions are generally very thick and heavy, which result in decreased interior space in a vehicle, as well as loss of fuel efficiency as a result of the added weight of the seating system.

### SUMMARY OF THE DISCLOSURE

According to one aspect of the present disclosure, a vehicle seating assembly includes a support frame partially enclosed by a panel assembly. A carrier is defined by a unitary polymeric matrix. A cushion assembly is molded over the carrier. An external peripheral gap is defined between the panel assembly and the carrier. The carrier and the cushion assembly are configured to flex under the weight of a passenger while the support frame remains stationary. An air movement assembly is in communication with the cushion assembly and is configured to move air through the carrier and the cushion assembly proximate a seating surface of the cushion assembly.

According to another aspect of the present disclosure, a vehicle seating assembly includes a frame assembly. A carrier includes a unitary polymeric matrix. A cushion assembly is molded over a front portion of the carrier such that a rear portion of the carrier is exposed. An external peripheral gap is defined between the carrier and the cushion assembly. An air movement assembly is in communication with the cushion assembly through the carrier and is configured to move air proximate a surface of the cushion assembly.

According to yet another aspect of the present disclosure, a method for constructing a vehicle seating assembly includes partially enclosing a rear portion of a support frame with a panel assembly. A carrier is provided that is defined by a flexible polymeric matrix. A multitude of perforations are formed through the carrier. A cushion assembly is molded over the carrier.

An external peripheral gap is formed between the panel assembly and the carrier. Air is moved through the carrier and the cushion assembly proximate a seating surface of the cushion assembly.

According to still another aspect of the present disclosure, a vehicle seating assembly is provided that is constructed by partially enclosing a rear portion of a support frame with a panel assembly. A carrier is provided that is defined by a flexible polymeric matrix. A multitude of perforations are formed through the carrier and a cushion assembly is molded over the carrier. An external peripheral gap is formed between the panel assembly and the carrier and is moved through the carrier and the cushion assembly proximate a seating surface of the cushion assembly. This method provides a fast and uniform approach to constructing a vehicle seating assembly and minimizes the number of parts needed to fabricate the same.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a top perspective view of a vehicle seating assembly of the present disclosure disposed in a vehicle;

FIG. 2 is an enlarged top perspective view of the vehicle seating assembly of FIG. 1;

FIG. 3 is a top perspective exploded view of one embodiment of the vehicle seating assembly of the present disclosure;

FIG. 4 is a top perspective partial exploded view of a seat of the vehicle seating assembly of the present disclosure;

FIG. 5 is a front perspective partial exploded view of a seatback of the vehicle seating assembly of the present disclosure; and

FIG. 6 is a front perspective partial exploded view of another seatback of the present disclosure.

### DETAILED DESCRIPTION OF THE EMBODIMENTS

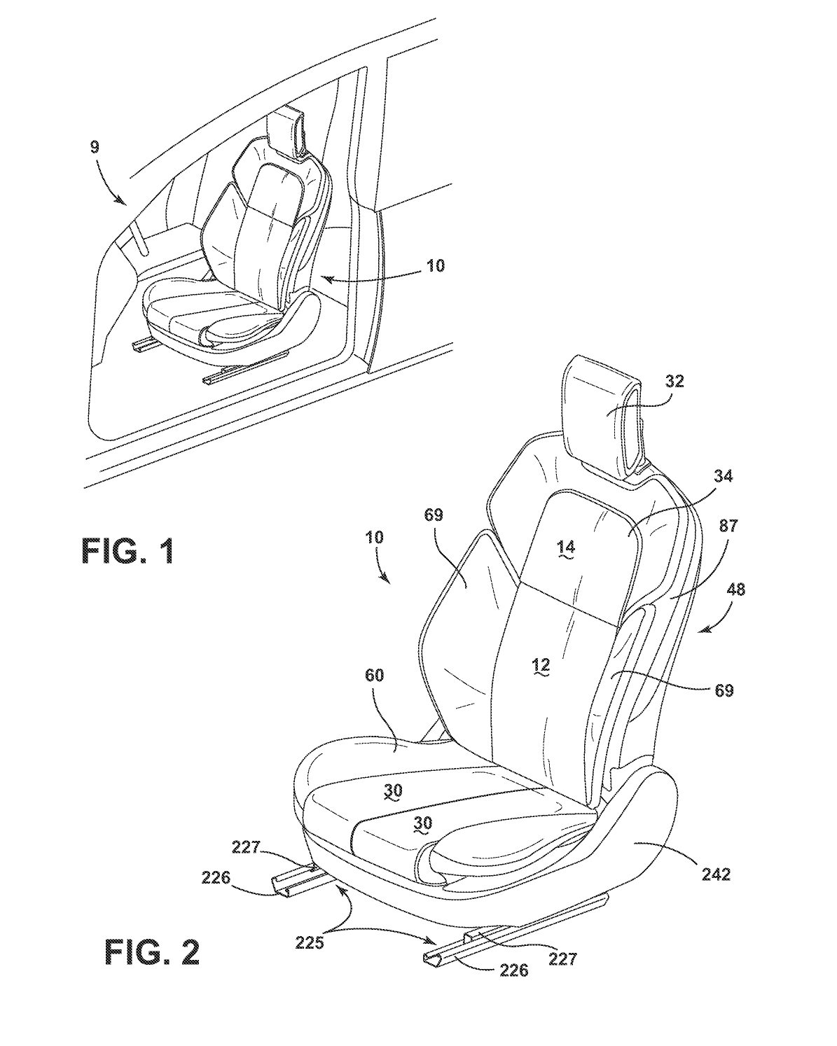

For purposes of description herein, the terms “upper,” “lower,” “right,” “left,” “rear,” “front,” “vertical,” “horizontal,” and derivatives thereof shall relate to the disclosure as oriented in FIG. 1. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

With reference to FIG. 1, the illustrated vehicle seating assembly 10 is configured for use in a vehicle of any type, including, without limitation, cars, vans, trucks, buses, etc. The vehicle seating assembly 10 is suspended on rails that allow movement of the vehicle seating assembly 10 in fore and aft directions. In addition, the vehicle seating assembly 10 may include a variety of comfort controls, including, for example, thigh support using independent thigh supports 30, lumbar support, and upper thoracic support. The vehicle seating assembly 10 includes a head restraint 32 that is disposed on the upper seatback 14. The head restraint 32 is moveable between forward and rearward positions to accommodate various sized heads of passengers, as well as different heights of passengers. The vehicle seating assembly 10 also includes controls specifically configured to adjust an upper thoracic portion 34 of the upper seatback 14.

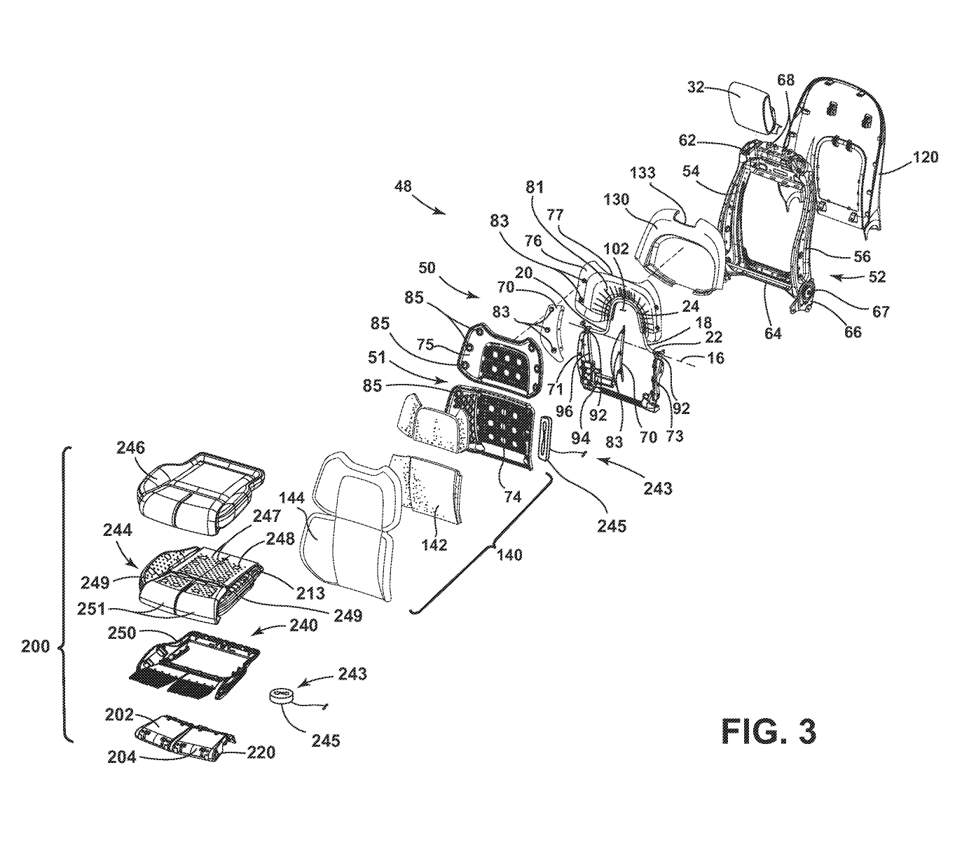

With reference to FIG. 3, the vehicle seating assembly 10 includes a seatback assembly 48 with a seatback suspension system 50 that is coupled with a seatback carrier 51 and which is supported on a frame 52. The frame 52 of the seatback assembly 48 of the vehicle seating assembly 10 includes a first side support 54 and a second side support 56 that define the frame 52. The first and second side supports 54, 56 of the frame 52 pivotally couple with a rear portion of a seat 60 and extend upward from the seat 60 to a top portion of the seatback assembly 48 and connect with an upper lateral brace 62. The upper lateral brace 62 of the seatback assembly 48 extends between the first and second side supports 54, 56. The head restraint 32 is operably coupled with the upper lateral brace 62 of the seatback assembly 48 and is substantially centered between the first and second side supports 54, 56. The upper lateral brace 62, as well as a lower lateral brace 64, of the seatback suspension system 50 are coupled with and span between the first and second side supports 54, 56, such that the seatback suspension system 50 is positioned generally between the head restraint 32 and the seat 60 to support the back of a passenger. It is contemplated that the head restraint 32 may be integrated with the top portion of the seatback assembly 48 or that the head restraint 32 may otherwise not be included on the vehicle seating assembly 10.

Referring again to FIG. 3, the first and second side supports 54, 56 extend upward from a recliner heart bracket 66 having a recliner heart 67 that pivotally couples the seatback assembly 48 with the seat 60. The first and second side supports 54, 56 are substantially parallel with each other and curve upward and rearward from the recliner heart bracket 66 to provide a curved shape that complements the shape of the spinal column of a passenger. Further, the first and second side supports 54, 56 are thicker and more robust proximate the recliner heart bracket 66 and taper as they extend upward to couple with the upper lateral brace 62 that extends orthogonally between the first and second side supports 54, 56. The upper lateral brace 62 of the frame 52 includes connectors 68 for securing the head restraint 32 at a central portion of the upper lateral brace 62 centrally between the first and second side supports 54, 56. The connectors 68 are defined by upward protruding tabs configured to couple with the head restraint 32.

With reference again to FIGS. 3-6, the lower seatback 12 of the seatback suspension system 50, as shown in FIG. 3, includes flex members 70 extending from each of a first side connector 71 and a second side connector 73 of the seatback assembly 48. The first and second side connectors 71, 73 are operably coupled with and support side bolsters 69 (FIG. 2). The lower seatback 12 is positioned adjacent to the seat 60 and includes a lower comfort carrier 74 that generally includes a lower thoracic region of the seatback assembly 48. The lower comfort carrier 74 supports the lower back of a passenger. Similarly, the upper seatback 14 of the seatback assembly 48 has an upper comfort carrier 75 that generally includes an upper thoracic region of the seatback assembly 48. The upper comfort carrier 75 is operably coupled with a curved flex member 76 operably coupled with the arcuate back support bar 18. The flex member 76 of the upper lateral brace 62 is disposed above the first and second side connectors 71, 73. The flex member 76 includes a recess 77 in a top portion thereof configured to adequately space the flex member 76 from the head restraint 32. The flex member 76 also includes a plurality of outwardly extending reinforcement flanges 81. The curved flex member 76 includes connecting features in the form of studs 83 that work as snap-fit connecting arrangements to secure with external peripheral apertures 85 of the upper comfort carrier 75 with the curved flex member 76. In a similar fashion, each of the flex members 70 includes connecting features in the form of studs 83 that couple with complimentary connecting features in the form of external peripheral apertures 85. In the illustrated embodiment, the arcuate back support bar 18 is coupled with the flex member 76 via a friction-fit engagement. Other connecting arrangements are also contemplated. It is conceivable that the lower and upper seatbacks 12, 14 may be integrated into a single component or several components spanning the seatback assembly 48. The flex members 70 of the lower seatback 12 extend forward and outward from the seatback assembly 48, as does the curved flex member 76, to create an external peripheral gap 87. Pivot pins 92 pivotally couple with the first and second side connectors 71, 73, generally above the lower lateral brace 64.

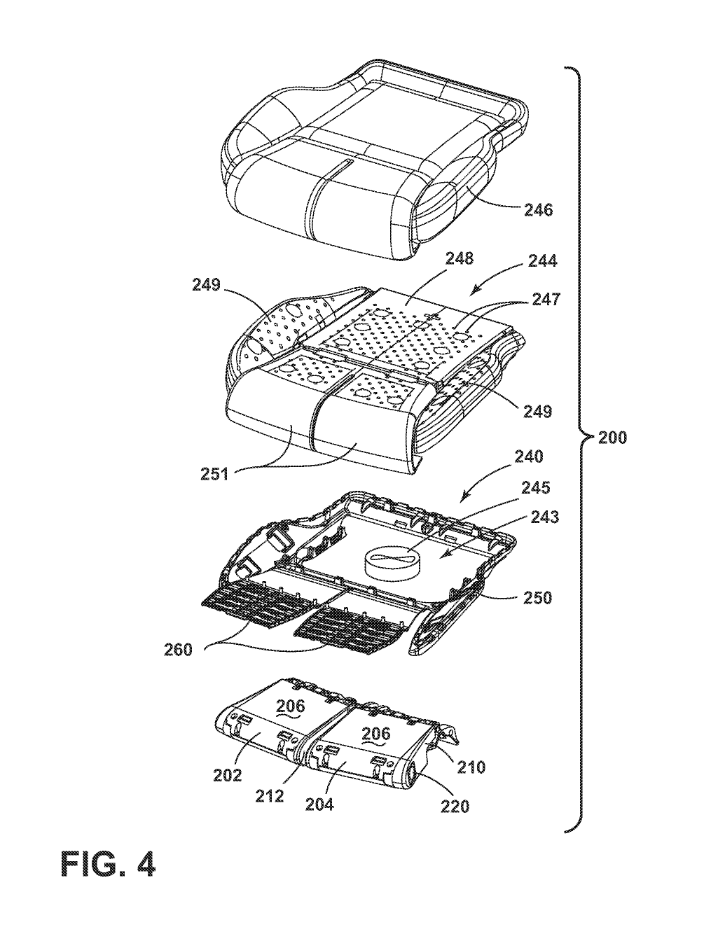

The flex member 76 of the upper seatback 14 of the seatback suspension system 50, as shown in FIGS. 4-6, generally defines a support basket that supports the upper back of a passenger. The flex member 76 of the upper lateral brace 62 is coupled with the arcuate back support bar 18 that laterally extends between the first and second side supports 54, 56 of the frame 52. The arcuate back support bar 18 is pivotally coupled relative to the pivot pins 92 to allow the flex member 76 to pivot forward and rearward about the pivot axis 16. Further, the arcuate back support bar 18 is operably coupled with a motor 94 via a linking member 96 to adjustably rotate the arcuate back support bar 18. Consequently, the upper seatback 14 can be pivoted forward and rearward relative to a plurality of angled positions to the lower seatback 12 and the frame 52, as described in more detail below.

With reference again to FIGS. 3-6, the pivot pins 92 generally define the pivot axis 16.

The upper seatback 14 includes a forward articulating portion that is operably coupled to the lower seatback 12. More specifically, the forward articulating portion is pivotally mounted to the lower seatback 12 at the pivot axis 16. The arcuate back support bar 18 is disposed in the upper seatback 14 and configured to rotate the upper seatback 14 between forward and rearward positions. The arcuate back support bar 18 includes a generally U-shaped configuration. The first and second generally linear members 20, 22 and the arcuate intermediate portion 24 generally define a central open space 102 in the seatback assembly 48. An articulation assembly operably couples the forward articulating portion of the upper seatback 14 with the seatback assembly 48 and allows for movement between the forward and rearward positions. Notably, the flex member 76 or support basket may be fastened to the arcuate intermediate portion 24 of the arcuate back support bar 18, or may be overmolded directly onto the arcuate intermediate portion 24. The arcuate back support bar 18 is connected to brackets that extend forward relative to the first and second generally linear members 20, 22 of the arcuate back support bar 18. The arcuate back support bar 18 is configured to rotate about a forward portion of the brackets at the pivot pins 92. Consequently, the entire upper seatback 14 can be rotated about a forward portion of the brackets.

The seatback suspension system 50, as shown in FIG. 3, includes the frame 52, which may be constructed of metal or other rigid material, and a hard back panel 120 configured to substantially enclose a rear portion of the frame 52. The vehicle seating assembly 10 also includes a front trim panel 130. The front trim panel 130, together with the hard back panel 120, generally define a shell that covers the frame 52 of the seatback assembly 48. The hard back panel 120 couples with the frame 52 to substantially enclose a rear portion of the frame 52. Similarly, the front trim panel 130 couples with a front portion of the frame 52 to enclose a top front portion of the frame 52. The front trim panel 130 includes a mounting cutaway 133 for accommodating the head restraint 32, which extends therethrough to couple with the upper lateral brace 62 of the frame 52. The front trim panel 130 and the hard back panel 120 also engage the frame 52 proximate the upper lateral brace 62, the first side support 54, and the second side support 56, substantially enclosing an edge portion of the frame 52. The front trim panel 130 and hard back panel 120 are typically molded with a polymer material and the frame 52 is constructed substantially of steel, aluminum, or another substantially rigid metal. It is conceivable that alternative materials or forming methods may be used for the shell and the frame 52. In addition, the shell, or portions thereof, may conceivably be integrated with the frame 52.

Referring once again to FIG. 3, the upper seatback 14 and lower seatback 12 of the seatback suspension system 50 are configured to operably couple with a passenger cushion assembly 140. More specifically, the flex members 70, 76 on the lower seatback 12 and upper seatback 14, respectively, extend forward to engage and support the back of a passenger. The passenger cushion assembly 140 includes the seatback carrier 51 (which has both the lower comfort carrier 74 and the upper comfort carrier 75), a cushion assembly 142, and a coverstock 144. The seatback carrier 51 may be integrally molded with the cushion assembly 142. The flex members 70, 76 operably couple to the lower comfort carrier 74 and the upper comfort carrier 75 in a snap-fit and friction-fit arrangement. The cushion assembly 142 is disposed between the lower comfort carrier 74 and the upper comfort carrier 75 and the coverstock 144 and between the lower comfort carrier 74 and the coverstock 144. It is conceivable that the passenger cushion assembly 140 may include more or fewer layers between the coverstock 144 and the upper comfort carrier 75. Further, it is conceivable that the passenger cushion assembly 140 may be one integral piece with the flex members 70, 76 of the seatback suspension system 50.

Referring again to FIGS. 1-5, the vehicle seating assembly 10 includes a seat 200. The seatback assembly 48 is operably coupled to a rear of the seat 200. Each of the first and second independently moveable thigh supports 202, 204 include an outer shell 205 having a top side 206, a bottom side 208, an exterior side 210, and an interior side 212. The first and second independently moveable thigh supports 202, 204 are operably coupled with a seat base 213 at a rear of the seat 200. The first and second independently moveable thigh supports 202, 204 are slidably supported on a slide assembly 214. Each of the first and second independently moveable thigh supports 202, 204 are independently laterally translatable forward and rearward relative to the seat 200. A button assembly 220 operably secures the first and second independently moveable thigh supports 202, 204 at any of a multitude of lateral positions. The button assembly 220 is disposed on the exterior side 210 of each of the first and second independently moveable thigh supports 202, 204 and held in place by a button housing 221. A spring assembly 222 urges each thigh support 202, 204 to a fully forward lateral position. A pivot member 224 operably couples each of the first and second independently moveable thigh supports 202, 204 to the seat 200. Each of the first and second independently moveable thigh supports 202, 204 are rotatable relative to the seat 200.

As previously noted, the vehicle seating assembly 10 is supported on rail slide assemblies 225 (FIG. 2) that include a rail 226 fixedly attached to a floor of the vehicle and a slide 227 fixedly attached to an underside or bottom of the seat 200 of the vehicle seating assembly 10. The rail 226 is slidably coupled with the slide 227, such that the vehicle seating assembly 10 can be moved between fore and aft positions inside the vehicle.

As clearly illustrated in FIGS. 3 and 4, the seat 200 includes a carrier 240 that is operably coupled with a seat base frame 242, and which is configured to support a seat cushion assembly 244 and a coverstock 246 disposed thereon. A climate control system 243, which may include an air movement assembly 245 is also provided, which can draw air from or blow air out of apertures 247 of the seat cushion assembly 244. Like the seatback, the seat cushion assembly 244 may be integrally molded with the carrier 240 without the aid of fasteners or adhesive. The seat cushion assembly 244 includes a main cushion 248, seat side bolsters 249, and forward thigh support cushions 251. The carrier 240 includes a peripheral carrier support 250 that interacts directly or indirectly with the seat base frame 242 (FIG. 2). The seat base frame 242 is operably coupled with the rail slide assemblies 225 referenced above. The first and second independently moveable thigh supports 202, 204 are operably coupled to a forward portion of the seat 200, and as noted above, are configured to rotate upward and downward relative to the seat 200 between raised and lowered positions, and are also configured to translate laterally between extended and retracted positions relative to the seat 200. The first and second independently moveable thigh supports 202, 204 are also independent. Specifically, the first independently moveable thigh support 202 may be at the raised position, while the second independently moveable thigh support 204 may be at the lowered position, or at any position in between the raised and lowered positions. First and second seat side supports are adjacent to the first and second independently moveable thigh supports 202, 204, and help cushion and provide support to the buttocks of a passenger.

The peripheral carrier support 250 also includes flexible supports in the form of leg extension trim carriers 260. Each leg extension trim carrier 260 provides support to the seat cushion assembly 244 at the forward thigh support cushions 251. The leg extension trim carriers 260 allow for movement of each of the first and second independently moveable thigh supports 202, 204 between extended and retracted positions, as well as between raised and lowered positions, as the first and second independently moveable thigh supports 202, 204 move. The leg extension trim carriers 260 can include a variety of constructions that may include apertures 259 or a generally solid construction. The apertures 259 minimize the weight of the leg extension trim carriers 260, and add to the overall flexibility of the leg extension trim carriers 260. Regardless, the leg extension trim carriers 260 include a body portion having waved or sinusoidal-type construction defined by alternating ridges and grooves, thereby providing an articulated or corrugated construction that allows for considerable flexibility as the first and second independently moveable thigh supports 202, 204 are adjusted. As will be disclosed in further detail below, the first and second independently moveable thigh supports 202, 204 include spring assemblies 270 configured to urge each of the first and second independently moveable thigh supports 202, 204 to pivot to a fully raised position, as well as spring assemblies configured to bias the first and second independently moveable thigh supports 202, 204 to a fully extended position.

With reference again to FIGS. 3 and 4, the independent flexible extension trim carriers 260 are configured to support the forward thigh support cushions 251 and a portion of the coverstock 246 thereon. At the same time, the leg extension trim carriers are configured to slide against the first and second independently moveable thigh supports 202, 204, as the first and second independently moveable thigh supports 202, 204 are articulated between raised and lowered positions and between retracted and extended positions. Accordingly, the leg extension trim carriers 260 allow for a uniform and constant feel to the passenger as the first and second independently moveable thigh supports 202, 204 are adjusted. In the illustrated embodiment, there are 10 flexible joints 262 and undulations 261 that allow for movement of the leg extension trim carriers 260. However, it is contemplated that any number of flexible joints may be present and that any number of undulations 261 may be present. Generally, a number of corrugations that results in a low profile, and does not substantially increase the overall surface area of engagement between the leg extension trim carrier 260 and the underlying independent leg extension and thigh support should be considered.

Referring again to the embodiment generally illustrated in FIGS. 1-6, the support frame 52 of the vehicle seating assembly 10 is partially enclosed by the panel assembly 120. The carrier 51 is defined by a polymeric matrix. The cushion assembly 142 is molded over the carrier 51. As previously noted, the external peripheral gap 152 is defined between the panel assembly 120 and the carrier 51. The carrier 51 and the cushion assembly 142 are configured to flex under the weight of a passenger while the support frame 52 remains stationary. The air movement assembly 243 is in communication with the cushion assembly 142 and is configured to move air through the carrier 51 and the cushion assembly 142 proximate a seating surface of the cushion assembly 142.

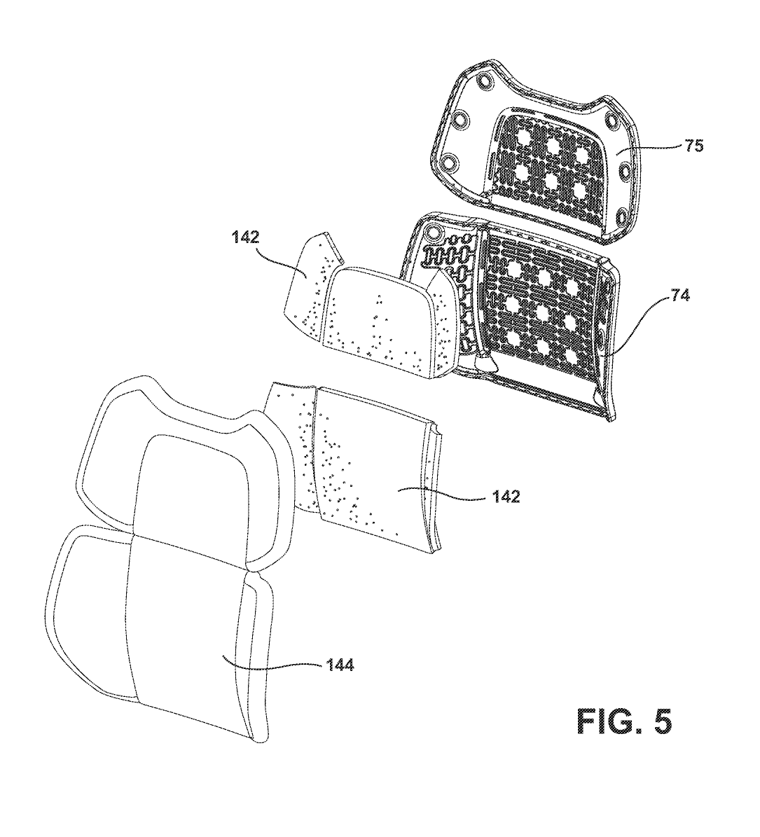

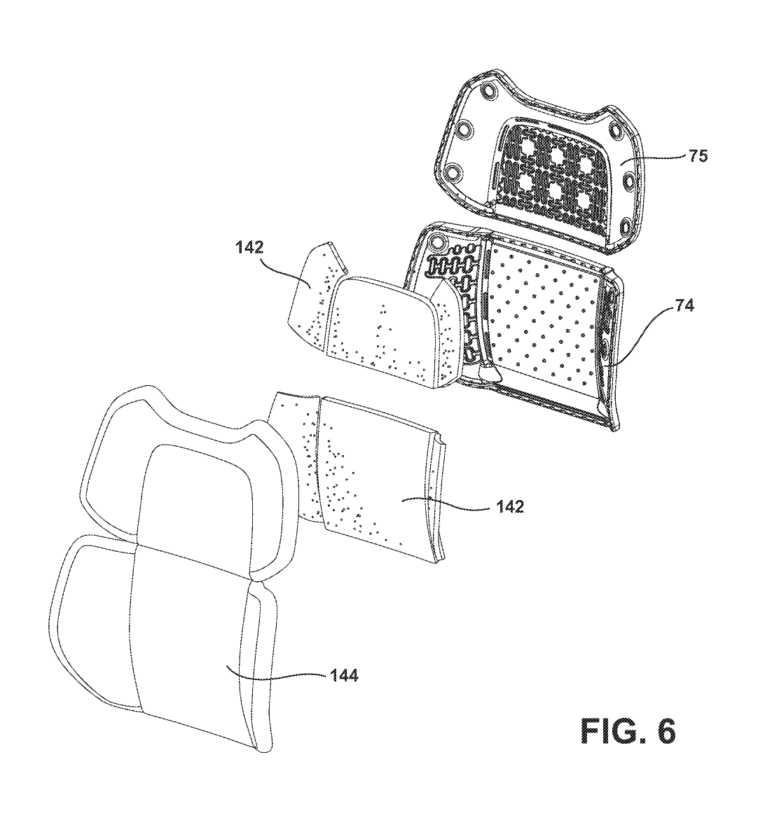

With reference once again to FIGS. 1-6, the cushion assembly 142 is generally formed by a thin foam layer disposed on the plastic or polymeric matrix of the carrier 51. The foam layer is mounted onto the polymeric matrix or integrally formed therewith. The polymeric matrix of the carrier 51 is then mechanically interlocked via the connecting features 83 disposed on the flex member 76 of the upper seatback 14. It is generally contemplated that the polymeric matrix of the carrier 51 is formed from a polymeric material that is flexible and allows for movement and flexure as a user adjusts the vehicle seating assembly 10. The integral molding formation of the carrier 51 with the thin foam layer results in a strong and durable, albeit flexible, support for passengers in the vehicle. This construction results in the carrier 51 providing a specific flexible matrix that allows an ideal amount of deflection of the seat bolsters and seatback bolsters in conjunction with the relative deflection of the thin foam. The patterns illustrated in FIGS. 5 and 6 have been found to provide an ideal deflection of the seating surfaces under the weight of a user.

In addition to the carriers 51 and 240 being flexible, thereby allowing for an ideal degree of deflection of the vehicle seating assembly 10, the carriers 51 and 240 also includes an ideal open volume of apertures 242 such that the air movement assembly 243 that is in communication with the seatback cushion assembly 142 seat cushion assembly 244 can move air through the carrier 51 and the cushion assembly 142. The movement of the air can be drawing air through the cushion assembly 142, or blowing air through the cushion assembly 142.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or moveable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. A vehicle seating assembly comprising:
a support frame partially enclosed by a panel assembly;
a carrier defined by a unitary polymeric matrix;
a cushion assembly molded over the carrier, wherein an external peripheral gap is defined between the panel assembly and the carrier, and wherein the carrier and the cushion assembly are configured to flex under the weight of a passenger while the support frame remains stationary; and
an air movement assembly in communication with the cushion assembly and configured to move air through the carrier and the cushion assembly proximate a seating surface of the cushion assembly.

2. The vehicle seating assembly of claim 1, further comprising:
a coverstock extending over the cushion assembly and configured to allow movement of air therethrough.

3. The vehicle seating assembly of claim 1, further comprising:
a carrier support disposed behind and mechanically interlocked with the carrier.

4. The vehicle seating assembly of claim 3, wherein the carrier includes external peripheral apertures configured to engage studs on the carrier support.

5. The vehicle seating assembly of claim 1, further comprising:
a headrest disposed above the support frame.

6. The vehicle seating assembly of claim 1, wherein the carrier includes an upper thoracic region and a lower lumbar region.

7. The vehicle seating assembly of claim 6, wherein the upper thoracic region includes a recess at a top portion thereof.

8. A vehicle seating assembly comprising:
a frame assembly;
a carrier including a unitary polymeric matrix;
a cushion assembly molded over a front portion of the carrier such that a rear portion of the carrier is exposed;
an external peripheral gap defined between the carrier and the cushion assembly; and
an air movement assembly in communication with the cushion assembly through the carrier and configured to move air proximate a surface of the cushion assembly.

9. The vehicle seating assembly of claim 8, further comprising:
a coverstock extending over the cushion assembly and configured to allow movement of air therethrough.

10. The vehicle seating assembly of claim 8, further comprising:
a carrier support disposed behind and mechanically interlocked with the carrier.

11. The vehicle seating assembly of claim 10, wherein the carrier includes external peripheral apertures configured to engage studs on the carrier support.

12. The vehicle seating assembly of claim 8, further comprising:
a headrest disposed above the support frame.

13. The vehicle seating assembly of claim 8, wherein the carrier includes an upper thoracic region and a lower lumbar region.

14. The vehicle seating assembly of claim 13, wherein the upper thoracic region includes a recess at a top portion thereof.

15. A method for constructing a vehicle seating assembly comprising:
partially enclosing a rear portion of a support frame with a panel assembly;
providing a carrier defined by a flexible polymeric matrix;
forming a multitude of perforations through the carrier;
molding a cushion assembly over the carrier;
forming an external peripheral gap between the panel assembly and the carrier; and
moving air through the carrier and the cushion assembly proximate a seating surface of the cushion assembly.

16. The method of claim 15, further comprising:
extending a coverstock over the cushion assembly that is configured to allow movement of air therethrough.

17. The method of claim 15, further comprising:
providing a carrier support disposed behind and mechanically interlocked with the carrier.

18. The method of claim 17, further comprising:
providing external peripheral apertures with the carrier that are configured to engage studs on the carrier support.

19. The method of claim 15, further comprising:
providing a headrest disposed above the support frame.

20. The method of claim 15, further comprising:
providing an upper thoracic region and a lower lumbar region with the carrier.
